(19) United States
(12) Patent Application Publication
(10) Pub. No.: US 2012/0182017 A1
(43) Pub. Date: Jul. 19, 2012

(54) Subsurface electromagnetic survey technique using expendable conductivity, temperature, and depth measurement devices

(76) Inventors: Rune Johan Magnus Mattsson, Trangsund (SE); Gustav Göran Mattias Südow, Solna (SE)

(21) Appl. No.: 12/930,746

(22) Filed: Jan. 14, 2011

(51) Int. Cl. G01V 3/00; G06G 7/48

(52) U.S. Cl. 324/365; 703/5

(57) ABSTRACT

A method for modeling conductivity distribution in a formation below a body of water includes measuring electromagnetic response of the formation with an electromagnetic survey system; measuring at least one of water conductivity, water dielectric constant, and water temperature with respect to depth in the water; generating an initial model of conductivity distribution of the formation; discretizing the measurements of at least one of water conductivity, water dielectric constant, and water temperature with respect to depth into at least one layer; generating a forward model of a response of the electromagnetic survey system to the initial model and the discretized measurements; comparing the forward model to the measured electromagnetic response to determine differences; adjusting the initial model to reduce the differences; and repeating generating a forward model, comparing the forward model to the measured electromagnetic response, and adjusting the initial model until the differences fall below a selected threshold.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates generally to the field of marine electromagnetic geophysical surveying. More specifically, at least in some embodiments, the invention relates to electromagnetic survey techniques that take account of electrical inhomogeneity in a body of water in which a survey is conducted.

Marine electromagnetic geophysical surveying is used to infer spatial distribution of electrical conductivity of rock formations below the bottom of a body of water such as a lake or ocean. The spatial distribution of conductivity is used to assist determining the presence of hydrocarbon bearing rock formations in the subsurface, potentially resulting in cost savings by better targeting drilling operations. One type of such surveying is known as “controlled source” electromagnetic surveying (“CSEM”), which generally includes inducing a time varying electromagnetic field in the subsurface formations and measuring one or more parameters related to a response of the subsurface rock formations to the induced electromagnetic field.

Devices for inducing such electromagnetic fields are generally referred to as “sources” or “transmitters” and may include, among other devices, spaced apart electrodes or wire coils disposed along or at the end of a cable. The cable may be towed by a vessel in the body of water. Time varying electric current is imparted across the electrodes or through the coils, generally from a power source located on the vessel, to induce a time varying electromagnetic field in the water and subsequently in the subsurface formations

Response of the subsurface formations is inferred by measuring properties of electromagnetic fields induced in the water as a result of the imparted electromagnetic fields. Such properties may include voltage, magnetic field amplitude, magnetic field gradient, and/or combinations of the foregoing at varying distances (offsets) from the electromagnetic transmitter.

The spatial distribution of electrical conductivity of the formations may be inferred by a technique called “inversion”, in which an initial estimate of the spatial distribution is made, a simulated response of the survey apparatus to such initial estimate is calculated, and differences between the measured response of the survey apparatus and the simulated response are analyzed. The initial estimate is adjusted based on the analysis, and the process is repeated. The foregoing steps may be iteratively repeated until differences between the simulated response and the measured response are minimized.

Inversion techniques known in the art rely on assumptions about the conductivity distribution in the body of water above the subsurface formations being surveyed, e.g., that the conductivity distribution is homogeneous and isotropic. It is desirable to have a technique that improves the accuracy of the inversion technique by improving the accuracy of assumptions of conductivity distribution in the body of water.

### SUMMARY OF THE INVENTION

A method according to one aspect of the invention for modeling conductivity distribution in a formation below a bottom of a body of water includes measuring electromagnetic response of the formation with an electromagnetic survey system. The method further includes measuring at least one of water conductivity, water dielectric constant, and water temperature with respect to depth in the body of water. The method further includes generating an initial model of conductivity distribution of the formation. The method further includes discretizing the measurements of at least one of water conductivity, water dielectric constant, and water temperature with respect to depth into at least one layer. The method further includes generating a forward model of a response of the electromagnetic survey system to the initial model and the discretized measurements. The method further includes comparing the forward model to the measured electromagnetic response to determine differences. The method further includes adjusting the initial model to reduce the differences. The method further includes repeating generating a forward model, comparing the forward model to the measured electromagnetic response, and adjusting the initial model until the differences fall below a selected threshold, thereby determining a final model of conductivity distribution in the formation.

A method according to another aspect of the invention for modeling conductivity distribution in a formation below a bottom of a body of water includes measuring electromagnetic response of the formation with an electromagnetic survey system by inducing a time varying electromagnetic field in the body of water and measuring at least one electromagnetic field property in the body of water. The method further includes measuring at least one of water conductivity, water dielectric constant, and water temperature with respect to depth by deploying at least one expendable probe from a vessel proximate a location of the measuring electromagnetic response. The method further includes generating an initial model of conductivity distribution of the formation. The method further includes discretizing the measurements of at least one of water conductivity, water dielectric constant, and water temperature with respect to depth into at least one layer. The method further includes generating a forward model of a response of the electromagnetic survey system to the initial model and the discretized measurements. The method further includes comparing the forward model to the measured electromagnetic response to determine differences. The method further includes adjusting the initial model to reduce the differences. The method further includes repeating generating a forward model, comparing the forward model to the measured electromagnetic response, and adjusting the initial model until the differences fall below a selected threshold, thereby determining a final model of conductivity distribution in the formation.

A method according to another aspect of the invention of data processing includes providing measurements from an electromagnetic survey system of electromagnetic response of a formation below a bottom of a body of water. The method further includes providing measurements of at least one of water conductivity, water dielectric constant, and water temperature with respect to depth in the body of water. The method further includes generating an initial model of conductivity distribution of the formation. The method further includes discretizing the provided measurements of at least one of water conductivity, water dielectric constant, and water temperature with respect to depth into at least one layer. The method further includes generating a forward model of a response of the electromagnetic survey system to the initial model and the discretized measurements. The method further includes comparing the forward model to the provided measured electromagnetic response to determine differences. The method further includes adjusting the initial model to reduce the differences. The method further includes repeating generating a forward model, comparing the forward model to the provided measured electromagnetic response, and adjusting the initial model until the differences fall below a selected threshold.

Other aspects and advantages of the invention will be apparent from the following description and the appended claims.

### BRIEF DESCRIPTION OF THE DRAWINGS

FIG. 1 shows an example embodiment of a marine electromagnetic survey system using an expendable conductivity, temperature, and depth (“xCTD”) probe according to the invention.

FIG. 2 shows a flow chart of an example embodiment of an inversion technique according to the invention.

### DETAILED DESCRIPTION

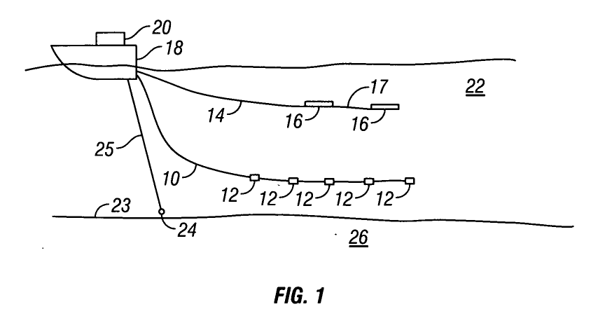

An example embodiment of a marine electromagnetic survey system is shown schematically in FIG. 1. The electromagnetic survey system may include a sensor cable 10 having thereon at longitudinally spaced apart positions a plurality of electromagnetic sensors 12 (hereinafter “sensors”). The sensors 12 and the configuration of the sensor cable 10 will be explained in more detail below. The sensor cable 10 may be towed by a survey vessel 18 moving on the surface of a body of water 22 such as a lake or an ocean. Towing the sensor cable 10 with the survey vessel 18 is only one possible implementation of a sensor cable. It is within the scope of the present invention for the sensor cable 10 to be towed by a second vessel (not shown) or deployed on the water bottom 23. It is also within the scope of the present invention to use electromagnetic sensor nodes (not shown) deployed at selected positions on the water bottom 23.

The survey vessel 18 may include thereon equipment, shown generally at 20 and referred to for convenience as a “recording system,” that may include devices (none shown separately) for navigation, energizing electrodes, coils, or other types of transmitters for inducing an electromagnetic field in the formations below the water bottom 23, and for recording and processing signals generated by the various sensors 12 on the sensor cable 10. The electromagnetic survey system shown in FIG. 1 may include an electromagnetic transmitter 17. In the illustrated embodiment, the electromagnetic transmitter 17 may consist of electrodes 16 disposed at spaced apart positions along an electrically insulated source cable 14 that may be towed in the water 22 by the survey vessel 18 or by a different vessel (not shown). The electrodes 16 may be energized at selected times by an electrical current source (not shown separately) in the recording system 20 or in other equipment (not shown) to induce an electromagnetic field in the formations below the water bottom 23. The current may be alternating current for frequency domain electromagnetic surveying or switched direct current (e.g., switching current on, switching current off, reversing current polarity, or sequential switching such as a pseudorandom binary sequence) for time domain electromagnetic surveying.

The electromagnetic transmitter 17 as configured in FIG. 1 may induce a horizontal dipole electric field in the subsurface when the electrodes 16 are energized by electric current. It is entirely within the scope of the present invention to induce vertical dipole electric fields in the subsurface, as well as to induce vertical and/or horizontal dipole magnetic fields in the subsurface. Inducing magnetic fields may be performed, for example, by passing electrical current through a loop antenna or solenoid coil. Accordingly, the direction of and the type of field induced is not intended to limit the scope of the invention. Further, the invention is applicable to use with both frequency domain (continuous wave) and transient induced electromagnetic fields. Similarly, the sensors 12 may be spaced apart electrodes, wire loops or coils, magnetometers, or any other device sensitive to one or more properties of a time varying electromagnetic field.

In the illustrated embodiment, one or more expendable conductivity, temperature, and depth (“xCTD”) probes 24 may be deployed from the survey vessel 18 during survey operations while the survey vessel 18 is moving. Each xCTD probe 24 includes sensors (not shown separately) for measuring electrical conductivity, temperature, and depth of the water 22. Each xCTD probe 24 is typically deployed by releasing the xCTD probe 24 over the side or stern of the survey vessel 18 at the end of a probe cable 25. Measurements made by the one or more xCTD probes 24 may be communicated over the associated probe cable 25 to the recording system 20. Alternatively, one or more of the xCTD probes may be deployed without associated probe cable 25 to measure and record electrical conductivity, temperature, and depth for later retrieval and uploading of data. Electrical conductivity and temperature measurements may be correlated to depth in the water by depth estimation based on a known rate of descent of the xCTD probe 24 and the elapsed time from the initial release of the xCTD probe 24. Alternatively, depth may be inferred by an included pressure sensor (not shown) on the xCTD probe 24. A non-limiting example of such an xCTD probe is made by The Tsurumi-Seiki Co., Ltd., 2-20, 2-Chome, Tsurumi-Ku, Yokohama, 230-0051, Japan and sold under model designation “XCTD-3.” Another example of such an xCTD probe is sold under product designation “Digital XCTD” by Lockheed Martin Maritime Systems & Sensors, Seven Barnabas Road Marion, Mass. 02738.

Signals detected by the sensors 12 may be recorded in the recording system 20 and later entered into a data processing technique known in the art as “inversion” in order to estimate distribution of electrical conductivity of the rock formations 26 below the water bottom. The detected signals may also be entered into such procedure as they are acquired. One such inversion technique is described, for example, in International Patent Application Publication No. WO 2003/023452. Typically, electromagnetic survey signal inversion techniques include generating an initial model of conductivity distribution in the subsurface formation, generating a simulated electromagnetic survey system response (often called a “forward model”), and comparing the forward model of the survey system response to the electromagnetic survey system response actually measured (“measured system response”). If the comparison indicates excessive difference between the forward model and the measured system response, one or more parameters of the initial model may be altered, perturbed, or adjusted, and the forward modeling and comparing repeated. Such procedure may be iteratively repeated with the one or more parameters being altered, perturbed, or adjusted until the differences between the forward model and the measured system response reach a minimum, or at least fall below a selected threshold. At such time, the adjusted forward model is considered to most closely represent the conductivity distribution in the subsurface formation. Parameters that may be adjusted include, for example and without limitation, the number of formation layers, thicknesses of each of the formation layers, and electrical conductivity and lateral extent of the formation layers.

Techniques known in the art for inversion of marine electromagnetic survey data include using certain assumptions about the electrical properties of the body of water. In such techniques, an electrical conductivity of a sample of the water may be measured at a known temperature or a measured temperature. The conductivity of the water is then estimated from the water surface to the water bottom using a predetermined temperature profile of the particular body of water in the geodetic location of the survey being conducted. Some techniques may estimate dielectric constant of the water using the predetermined temperature profile. The actual electrical properties of the water, e.g., conductivity and dielectric constant, may differ from those estimated using the foregoing techniques because of localized variations in water temperature and salinity with respect to depth.

In an example embodiment of a method according to the invention, data from the xCTD probe 24 are measured as the survey vessel 18 moves along each of a plurality of survey “lines.” Such survey lines may include the lines along which either or both the electromagnetic transmitter 17 and sensors 12 move through the body of water, or just the lines along which the electromagnetic transmitter 17 moves when ocean bottom deployed sensors are used, e.g., ocean bottom cables or nodes.

The xCTD probe 24 data may be used to construct a profile with respect to water depth of the electrical properties (conductivity and/or dielectric constant) and temperature. For example, the profile may comprise data points along each survey line. The profile may be used as input to the inversion technique. Such input may take the form, for example, of discretizing the probe data into one or more “layers” in the body of water 22 from the surface to the water bottom. Each such layer may have a unique thickness, electrical conductivity, dielectric constant, and/or temperature. The number of such layers into which the water is discretized may depend on, for example, the amount of change in conductivity, dielectric constant, and/or temperature of the water 22 from the surface to the water bottom. In some embodiments, only the temperature measurements may be used; the conductivity may be inferred from the temperature measurements. In some embodiments, only the conductivity measurements may be used. In some embodiments, the thickness of one or more water layer may vary along the survey line.

After the water 22 is discretized into one or more individual layers having unique thickness, conductivity, dielectric constant, and/or temperature, the discretized water layers may be entered as part of an initial model of the conductivity structure of both the subsurface formations 26 and the water 22. Then an inversion technique as described above may be performed. In such inversion technique, however, the properties of the layer(s) in the body of water 22 may remain unchanged in each iteration of the inversion, because their values have been substantially determined by the measurements from the xCTD probe 24. The remainder of the inversion technique, however, may be performed as it would be ordinarily performed with respect to layers in the rock formations 26 below the water bottom 23.

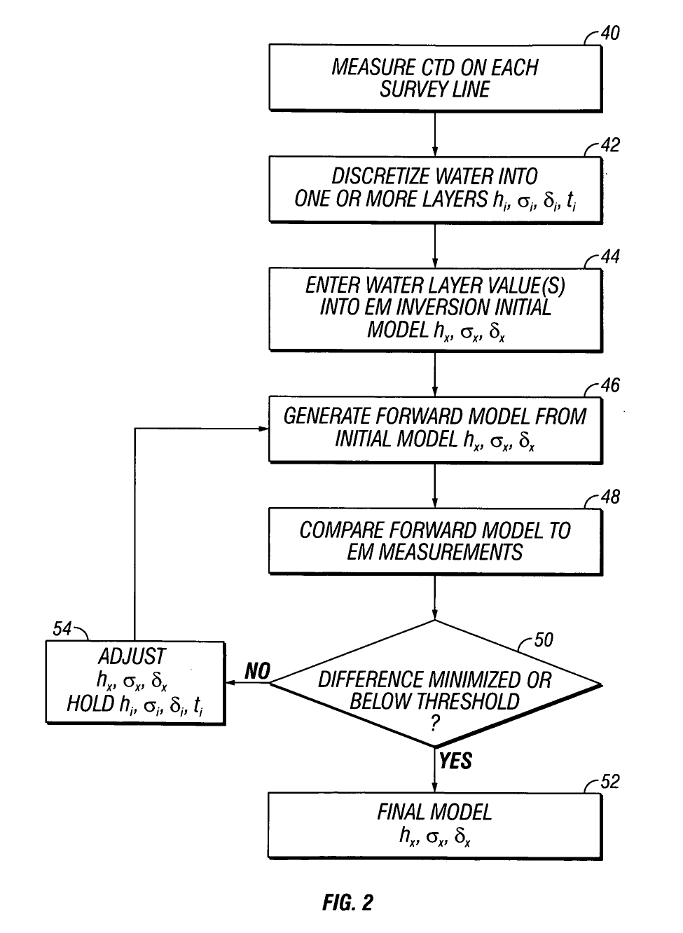

An example embodiment of an inversion technique according to certain embodiments of the invention may be better understood with reference to the flow chart in FIG. 2. At 40 xCTD data may be acquired along one or more survey lines, that is, as the survey vessel (18 in FIG. 1) moves while towing the EM transmitter and/or sensors. At 42, the data from the expendable probe may be used to discretize the water into one or more (i) layers each having a unique value of thickness h₁, conductivity σᵢ, dielectric constant δᵢ, and/or temperature tᵢ. The values of the one or more discretized layers in the water (22 in FIG. 1) may be entered into an initial model consisting of one or more layers of rock in the formations (26 in FIG. 1) below the water bottom (23 in FIG. 1), as shown at 44. Each such layer of rock formation may have a unique value of thickness, hₓ, conductivity σₓ, and/or dielectric constant δₓ. At 46, the foregoing discretized water layer(s) and rock layer(s) in the initial model may be used to generate a forward model of the electromagnetic survey system response. At 48, the forward model is compared to the electromagnetic (“EM”) measurements made by the electromagnetic survey system during surveying operations. At 50, a determination is made as to whether the difference between the forward model and the EM measurements is at minimum or is below a selected threshold. If so, a final model of the conductivity distribution of the rock layer(s) in the subsurface is determined. If the difference is not minimized or below a selected threshold, at 54, the value(s) of one or more parameters of the rock layer(s), e.g., thickness, hₓ, conductivity σₓ, and/or dielectric constant δₓ may be adjusted or perturbed, and the process returned to the forward model generation, at 46. Note that in the present embodiment, the parameters of the discretized water layer(s) may be held constant, because these values have been determined from the measurements made by the xCTD probe (24 in FIG. 1). After adjustment of the initial model at 54, the process from 46 to 50 may be repeated until the difference falls below a selected threshold or reaches a minimum. The values of thickness, hₓ, conductivity σₓ, and dielectric constant δₓ for the rock formation layer(s) may then be considered to be a best approximation of the distribution of electrical conductivity in the subsurface.

Methods according to the invention may provide more accurate results in determining conductivity distribution of formations below the bottom of a body of water by more accurately characterizing the effects of the body of water on electromagnetic measurements made therein. The more accurate conductivity distribution may be used to assist determining the presence of hydrocarbon bearing rock formations in the subsurface, potentially resulting in cost savings by better targeting drilling operations. These methods might be especially advantageous for shallow water electromagnetic geophysical surveys.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for modeling conductivity distribution in a formation below a bottom of a body of water, comprising:
(a) measuring electromagnetic response of the formation with an electromagnetic survey system;
(b) measuring at least one of water conductivity, water dielectric constant, and water temperature with respect to depth in the body of water;
(c) generating an initial model of conductivity distribution of the formation;
(d) discretizing the measurements of at least one of water conductivity, water dielectric constant, and water temperature with respect to depth into at least one layer;
(e) generating a forward model of a response of the electromagnetic survey system to the initial model and the discretized measurements;
(f) comparing the forward model to the measured electromagnetic response to determine differences;
(g) adjusting the initial model to reduce the differences; and
(h) repeating steps (e) through (g) until the differences fall below a selected threshold, thereby determining a final model of conductivity distribution in the formation.

2. The method of claim 1 wherein measuring at least one of water conductivity, water dielectric constant, and water temperature with respect to depth uses at least one expendable conductivity, temperature, and depth probe launched from a survey vessel.

3. The method of claim 2 wherein measuring at least one of water conductivity, water dielectric constant, and water temperature with respect to depth occurs while the survey vessel is in motion.

4. The method of claim 1 wherein measuring electromagnetic response of the formation comprises inducing an electromagnetic field in the body of water and measuring a response thereto with electromagnetic sensors disposed in the body of water.

5. The method of claim 4 wherein a transmitter towed by a survey vessel is used to induce the electromagnetic field.

6. The method of claim 4 wherein the electromagnetic sensors are disposed on a cable towed by a survey vessel.

7. The method of claim 1 wherein the initial model includes at least one value of dielectric constant.

8. The method of claim 1 wherein the at least one layer has a conductivity and thickness related to the measured at least one of water conductivity, water dielectric constant, and water temperature.

9. The method of claim 8 wherein
the measuring at least one of water conductivity, water dielectric constant, and water temperature with respect to depth is conducted along a survey line; and
the thickness varies along the survey line.

10. The method of claim 1 wherein measuring electromagnetic response comprises measuring at least one electromagnetic field property selected from the group of properties consisting of: voltage, magnetic field amplitude, magnetic field gradient, and any combination thereof.

11. A method for modeling conductivity distribution in a formation below a bottom of a body of water, comprising:
(a) measuring electromagnetic response of the formation with an electromagnetic survey system by inducing a time varying electromagnetic field in the body of water and measuring at least one electromagnetic field property in the body of water;
(b) measuring at least one of water conductivity, water dielectric constant, and water temperature with respect to depth by deploying at least one expendable probe from a vessel proximate a location of the measuring electromagnetic response;
(c) generating an initial model of conductivity distribution of the formation;
(d) discretizing the measurements of at least one of water conductivity, water dielectric constant, and water temperature with respect to depth into at least one layer;
(e) generating a forward model of a response of the electromagnetic survey system to the initial model and the discretized measurements;
(f) comparing the forward model to the measured electromagnetic response to determine differences;
(g) adjusting the initial model to reduce the differences; and
(h) repeating steps (e) through (g) until the differences fall below a selected threshold, thereby determining a final model of conductivity distribution in the formation.

12. The method of claim 11 wherein measuring at least one of water conductivity, water dielectric constant, and water temperature with respect to depth occurs while the vessel proximate the location of the measuring is in motion.

13. The method of claim 11 wherein a transmitter towed by a survey vessel is used to induce the time varying electromagnetic field.

14. The method of claim 13 wherein the vessel proximate the location of the measuring is the survey vessel.

15. The method of claim 11 wherein measuring at least one electromagnetic field property in the body of water utilizes electromagnetic sensors disposed on a cable towed by a survey vessel.

16. The method of claim 15 wherein the vessel proximate the location of the measuring is the survey vessel.

17. The method of claim 11 wherein the initial model includes at least one value of dielectric constant.

18. The method of claim 11 wherein the at least one layer has a conductivity and thickness related to the measured at least one of water conductivity, water dielectric constant, and water temperature.

19. The method of claim 18 wherein
the measuring at least one of water conductivity, water dielectric constant, and water temperature with respect to depth is conducted along a survey line; and
the thickness varies along the survey line.

20. The method of claim 11 wherein measuring electromagnetic response comprises measuring at least one electromagnetic field property selected from the group of properties consisting of: voltage, magnetic field amplitude, magnetic field gradient, and any combination thereof.

21. A method of data processing comprising:
(a) providing measurements from an electromagnetic survey system of electromagnetic response of a formation below a bottom of a body of water;
(b) providing measurements of at least one of water conductivity, water dielectric constant, and water temperature with respect to depth in the body of water;
(c) generating an initial model of conductivity distribution of the formation;
(d) discretizing the provided measurements of at least one of water conductivity, water dielectric constant, and water temperature with respect to depth into at least one layer;
(e) generating a forward model of a response of the electromagnetic survey system to the initial model and the discretized measurements;
(f) comparing the forward model to the provided measured electromagnetic response to determine differences;
(g) adjusting the initial model to reduce the differences; and
(h) repeating steps (e) through (g) until the differences fall below a selected threshold.

22. The method of claim 21 wherein the at least one layer has a conductivity and thickness related to the provided measurements of at least one of water conductivity, water dielectric constant, and water temperature.

23. A method for electromagnetic surveying comprising:
towing an electromagnetic transmitter in a body of water with a survey vessel;
inducing an electromagnetic field in formations below the body of water with the electromagnetic transmitter;
detecting electromagnetic signals with a plurality of sensors disposed in the body of water; and
measuring a characteristic of the body of water as a function of water depth, wherein the characteristic of the body of water is selected from the group consisting of: conductivity, and temperature.

24. The method of claim 23 wherein the detecting the electromagnetic signals and the measuring the characteristic of the body of water occur substantially simultaneously.

25. The method of claim 23 wherein the inducing the electromagnetic field and the measuring the characteristic of the body of water both occur while the vessel moves along a survey line.

26. The method of claim 23 further comprising constructing a profile of the characteristic of the body of water with respect to water depth.

27. The method of claim 26 further comprising using the constructed profile and the detected electromagnetic signals in a data processing inversion.

28. The method of claim 23 wherein the measuring the characteristic of the body of water comprises deploying an xCTD probe from the survey vessel.

29. The method of claim 23 wherein the plurality of sensors are disposed on one or more streamers towed by the survey vessel.
